(19) United States
(12) Patent Application Publication
(10) Pub. No.: US 2010/0151971 A1
(43) Pub. Date: Jun. 17, 2010

(54) METHOD FOR PAINTING GOLF BALLS

(75) Inventors: Thomas L. Mydlack, Rochester, MA (US); Ajay Vora, Foxboro, MA (US); Robert A. Wilson, Sagamore, MA (US)

Correspondence Address: ACUSHNET COMPANY, 333 BRIDGE STREET, P. O. BOX 965, FAIRHAVEN, MA, 02719, US

(73) Assignee: Acushnet Company

(21) Appl. No.: 12/336,728

(22) Filed: Dec. 17, 2008

(51) Int. Cl. A63B 37/12; B05D 3/00; B05D 1/02

(52) U.S. Cl. 473/378; 427/331

(57) ABSTRACT

The present invention relates to a method for painting dimpled golf balls that are moving along an endless conveyor. The method employs paint guns operating at a relatively low atomizing air pressure, and make contact with the golf ball surface at an angle between about 5° to 60°. The paint guns are continually in the on position and the paint neither coagulates in the gun nozzle nor forms puddles in the dimple cavities. The number of golf ball painted per gallon of paint is dramatically increased as is the number of ball painted per time period.

### FIELD OF THE INVENTION

The present invention relates to an improved method for painting golf balls. In particular, the present invention is directed to a method for improving the aerodynamic performance and coating quality of golf balls.

### BACKGROUND OF THE INVENTION

Conventional golf balls generally include a core surrounded by a cover. The cover forms a spherical outer surface of the ball and the surface includes a plurality of dimples. The core and/or the cover can be formed of a plurality of layers and the core can include a solid or fluid-filled center surrounded by windings and/or molded material. The covers of presently available golf balls are typically formed from a variety of materials such as balata, polyurethane and ionomer resins such as SURLYN® and IOTEK®, depending upon the desired performance characteristics of the golf ball and desired properties of the cover.

Golf balls are provided in a variety of colors. Conventionally they are white, but they may be manufactured with essentially any desired color. The color is imparted either by layers of paint applied to the outer surface of the ball or by incorporating a pigment directly into the cover composition. Typically, in a painted ball, a first coat or primer layer of paint is applied, followed by a second, i.e., finishing coat or layer. After a ball has been colored, identifying indicia such as a trademark, logo, identification number, model name and/or number, and the like can be stamped or printed onto the ball.

It is important that golf balls be capable of withstanding a variety of weather conditions such as sunlight, extreme temperature ranges, and immersion in water, preferably for an extended period. Further, the surface of a golf ball is flexed every time it is impacted with a club and, consequently, it must be able to withstand repeated stresses without damage to the cover. There are multiple sources of other types of degradation to the ball, for example, being struck with a grooved club head or landing on a rocky or abrasive surface such as a cart path. Resistance to such impact and abrasion is an important feature of a golf ball.

It is further desirable for manufacturers of golf balls that their golf balls be resistant to delamination or chipping of the paint layers, as aesthetic defects negatively impact the public perception of golf ball quality. Likewise, golf ball manufacturers prefer to protect trademarks, logos or other identifying indicia which identifies the brand of the ball to the playing public.

Golf balls are, therefore, generally subjected to at least one clear or pigmented top coat, primer coat, or other protective coat, which covers the golf ball outer surface in order to improve the overall appearance of the ball, e.g., high-gloss surface. In addition, a top coat helps to protect any painted or primed layers and/or printed patterns thereon from degradation during the golf ball's normal useful life. Such coatings can be applied as a single layer or as a multiple layers.

Paint layers or protective coating materials can be applied by various methods. One such method uses a coating gun to spray the paint or coating material as atomized particles. In this method, an operator must visually observe the spray as a ball is coated, determine whether the spray adequately coats the ball, and then manually change the orientation or location of the gun, as necessary. As a result, a number of balls may be improperly coated during set-up, which leads to increased manufacturing costs due to wasted materials. In addition, an operator must shut down the line to make routine measurements, e.g., spray volume per pulse, and adjust if necessary, which leads to production inefficiencies due to line downtime on the line.

Water-based coatings, in general, while desirable due to the low toxicity of the solvent, are much harder to evaporate than volatile organic materials, and therefore, are energy intensive, requiring expensive drying ovens to remove the water. Moreover, coatings and inks used in spraying and pad printing techniques typically involve volatile organic compounds (VOC) found in the compounds used. Manufacturers of printed and painted products are strongly affected by federal and local regulations, such as those by the Environmental Protection Agency (EPA which regulates and imposes restrictions on the emission of VOCs, such as methyl ethyl ketone, acetone, toluene, alcohols, and chlorinated solvents, to the atmosphere. These EPA mandates, as applied in the golf ball industry, translate to the number of golf balls coated per gallon of paint used. Thus, in addition to the quality of paint coverage, it is very important to minimize paint waste and paint components released into the work atmosphere. Thus golf ball painting processes cycle the operation of the paint guns to avoid wasting paint. But the cycling off/on of paint guns creates quality control problems due to paint flooding, extensive wear resulting in poor quality, and also the necessity of high operating pressure on the guns.

### SUMMARY OF THE INVENTION

A turbo spray method for painting dimpled golf balls in accordance with the principles of the present invention provides for an application of a thin coating of paint. The golf balls are rotated while each is disposed within one of a plurality of open-sided and tightly grouped spindle cups that are attached to an endless conveyor. The cups move rapidly through an enclosed painting station and the golf balls have a coat of paint applied by continuously spraying paint guns operating at a fluid tank pressure of about 6 psi. The sprayed paint is directed on an angled plane to the ball surfaces with about a 5°-60° angle to the surface of the ball being preferred, and the close grouping of spindles allows for the continuous spray of paint, whereby the continuous spray over the ball surfaces does not allow for any paint to miss a ball surface at any time. By angling the spray guns, the formation of “flooding” (pools of paint) therein causing puddles in the dimples is essentially eliminated.

An object of the invention is the elimination of paint gun cycling, which is the off and on constant pulsing of the paint gun, and therein creating an improvement in the uniformity and consistency of the atomized spray. When the paint guns are pulsated to the off position, they cease to shoot paint during that time, thereby a build-up of paint accumulates in the nozzle of the gun. As stated above they must be cycled off/on to comply with limits set by the EPA as to how much of the paint can be wasted to the surrounding atmosphere. Before the present invention, it was deemed necessary to overcome the build-up of fluid pressure paint and pressure in the gun nozzle, and this was accomplished by operating the gun at a relatively high pressure (15 psi). As stated, the problem that occurs when the guns are cycled is that when the guns are shut off, the paint that accumulates in the nozzle of the guns, cause a “burst” of paint against the ball surface when the gun is subsequently fired, which therein causes “flooding” of the ball dimples. “Flooding”, is a term used to describe the puddles of paint that accumulate in the dimples. Besides the aesthetic problems, “flooding” creates serious aerodynamic issues within a golf ball.

The turbo spray method of the present invention provides for the nozzle of the paint gun to be kept in a fully opened and functioning position at all times, (it never cycles) and the subsequent elimination of paint build-up in the nozzle allows for the paint gun to function at a much lower operating pressure level (6 psi). The inherent benefit of operating at a lower pressure is that the air connected to the paint gun has the opportunity to provide a more gentle, uniform and mistier spray pattern than the spray at a higher pressure, and subsequently provides for a better application of paint to the ball.

Another object of the invention is that, not only does the present process provide full compliance with the mandates of the EPA, the present invention actually provides a dramatic improvement over these mandates. For the production facilities of the Acushnet Company, which is the Assignee of the present invention, the EPA has mandated minimum requirements for the number of golf balls per gallon of paint used, which happens to be 6700 balls painted per gallon of paint. Until the present invention, in order to meet this requirement it was necessary to continually cycle the paint gun between the open and close position, to avoid the release of unnecessary airborne emissions of solvents. The paint gun therefore had to fire the previously discussed burst of paint head-on at a rotating ball, and then quickly close during the time it took for the next ball to be moved into painting position, thus cutting down on wasted paint. Cycling is undesirable but unfortunately necessary to maintain the process within the mandates of the EPA. The present invention provides for an increase of up to 58% for the number of golf balls painted per gallon of paint.

Another object of the invention is an increase in the number of golf balls painted per minute. The combination of the balls being grouped very tightly together (two inch from center of one ball to the center of the next ball versus three inch center utilized traditionally in the industry), the paint guns being physically closer, the angle of the paint guns to the surface of the balls being about 32°, and the fact that the guns continuously fire paint, all help to provide a golf ball that has better paint coverage without any puddles of paint accumulating in the dimples and better uniform coverage on the dimple edges. A bonus benefit if that the number of balls painted per painting station is increased by more than 50%, and the number of balls covered per gallon of paint increases from a maximum of 7,400 to over 11,200 golf balls.

### BRIEF DESCRIPTION OF THE DRAWINGS

FIG. 1 is a prior art pictorial view of paint guns spraying a coating of paint perpendicularly at a golf ball.

FIG. 2 is a pictorial view of the paint guns of the present invention in relationship to the balls.

FIG. 3 is a pictorial view of the paint guns of the present invention spraying paint at predetermined angles to the golf ball surfaces.

FIG. 4 is an enlarged cross-sectional view of a golf ball dimple surface having been painted by the prior art process and therein having typically a paint puddle pooled within the dimple.

FIG. 5 is an enlarged cross-sectional enlarged view of a golf ball dimple surface and the dimple edge after being painted by the present invention's Turbo Spray process.

### DETAILED DESCRIPTION OF THE INVENTION

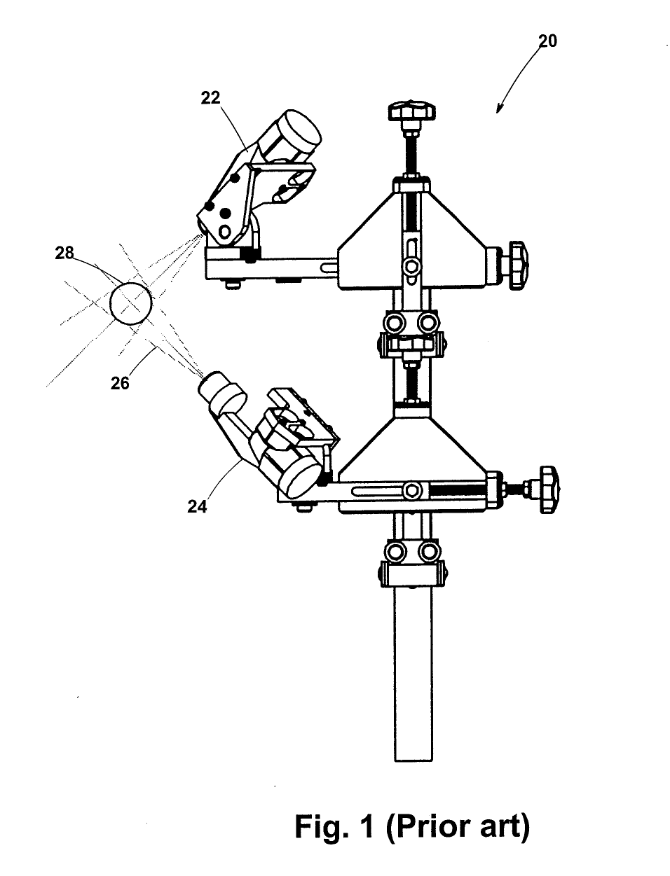

FIG. 1 depicts a prior art painting apparatus 20 operating in a paint booth (not shown) and a pair of paint guns, an upper gun 22 and a lower gun 24, both spraying a coat of paint 26 onto a surface of a golf ball 28, as is the typical process in a golf ball painting booth, and of which is generally well known to persons skilled in the art. Each spray gun generally includes a flow nozzle at the free end, a paint pressure air supply line, an atomizing air supply line, and a paint supply line. The spray guns are not detailed in the drawings as they are well known in the art. The nozzle of each gun allows a spray of paint to emit from the gun towards balls moving in a non-stop motion on a conveyor, which has been eliminated from the drawings for clarity. The paint pressure air supply line (not shown) not only provides the pressure for driving the paint out of the paint gun, but it also provides for atomizing the paint spray. There is a paint supply line which is a conduit for directing a supply of paint from a container (not shown) to the gun. The paint from the spray guns 22, 24, is in the form of a mist and in the prior art, as seen on FIG. 1, this paint spray is directed perpendicularly to the surface of the golf balls 28. Each golf ball is disposed within a spindle cup 30 and upon approach to the painting location, is rotated within the cup 30 while paint is applied. Neither in the prior art nor in the present invention does the conveyor holding the ball 28 and spindle cup 30 stop or pause in front of the painting guns, for the painting process. In the prior art, each ball in a spindle cup 30 is painted while directly in front of the paint guns 22, 24, which are held open in the spraying position long enough for a coating of paint to be applied. In the prior art, the paint guns are then cycled from the open position to the off position so as not to waste paint during the time period that it takes for the next ball on the conveyor to move into painting position. In the prior art it is also necessary to cycle the guns to the off position so that excess volatile solvents are not released into the surrounding atmosphere while the conveyor moves the next ball into the painting position.

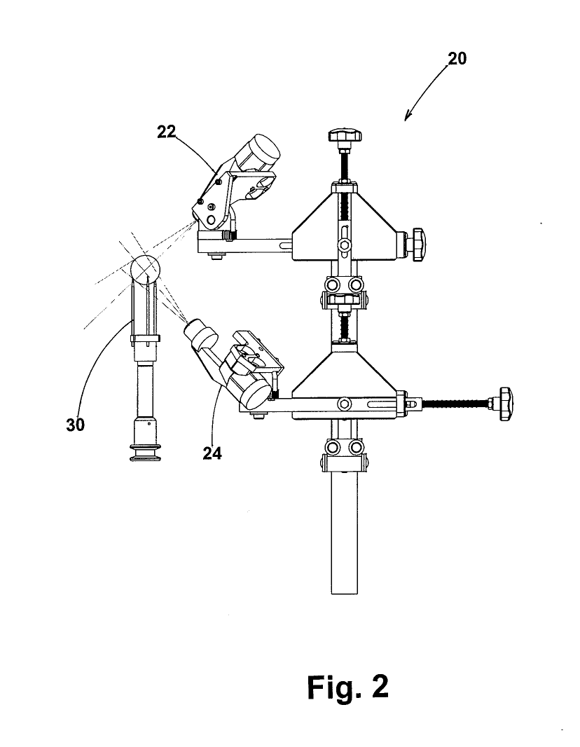

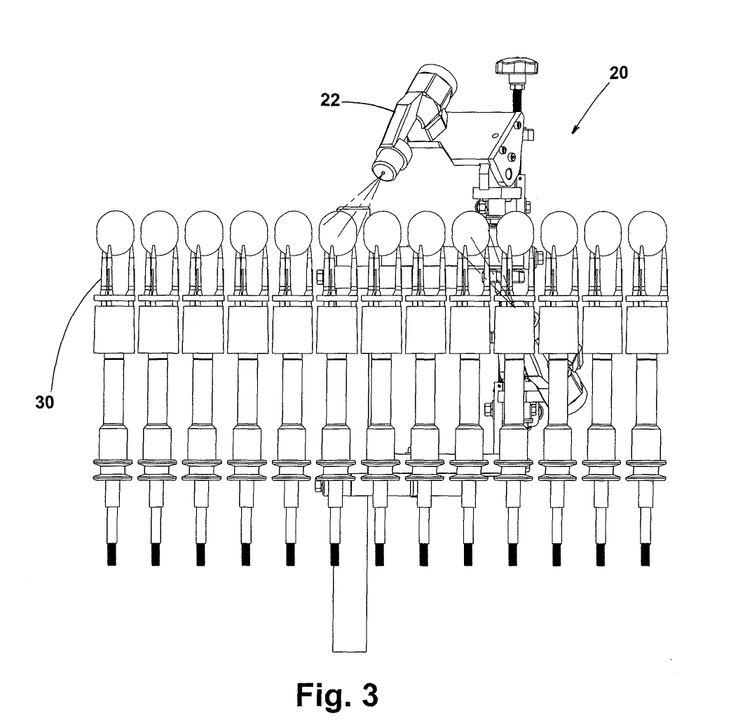

The turbo spray method of the present invention, as depicted in FIGS. 2 and 3, adjusts the position of the spray guns whereby they each spray a mist of paint, not perpendicularly to the golf ball surface, but rather at an angle of about 5° to 60°, preferably from about 28° to 40°, to the ball surface. The spindle cups 30 of the present invention are bunched closer together i.e. 2 inch center line versus at least 3 inch center lines of the prior art. In the present invention, it is possible to bunch the spindle cups 30 closer together because the paint guns remain on and are constantly spraying paint at an angle to the ball surface. In the prior art, the guns constantly cycle in the on/off position whereas in the present invention the guns maintain a constant spray of paint. The increased number of balls painted per time period in the present invention, improves production rates at least 58% for the same paint booth layout. There is also an improvement in the number of balls painted per gallon of paint. For the Acushnet Company, Assignee of the present invention, the EPA mandates a quota of 6,700 balls to be painted per gallon of paint. Before the present invention it was possible to achieve as high as 8,000 balls per gallon of paint, but with the production steps of the present invention that number has increased to greater than 12,000 balls per gallon of paint.

As previously discussed, the benefits of the present invention which include greater paint economy (balls per gallon of paint) and increased production rates (number of balls per minute) are significant, but the primary inventive concepts of the present invention are the prevention of paint “flooding” in the dimples of the golf ball and also coverage of the dimple edge angle. It is to be noted that when the paint guns are cycled between the closed/opened positions, there is always a build-up of paint in the gun nozzle during the time that the gun is shut off. And, each time the gun opens and fires, the excess build-up of paint causes a burst of paint upon the ball surface. When combined with the additional run-off of paint from the dimple edge angle, a puddle of paint forms in the dimple cavity. In addition to inadequate paint coverage, the paint puddle may cause significant problems with the aerodynamic flight performance of the ball.

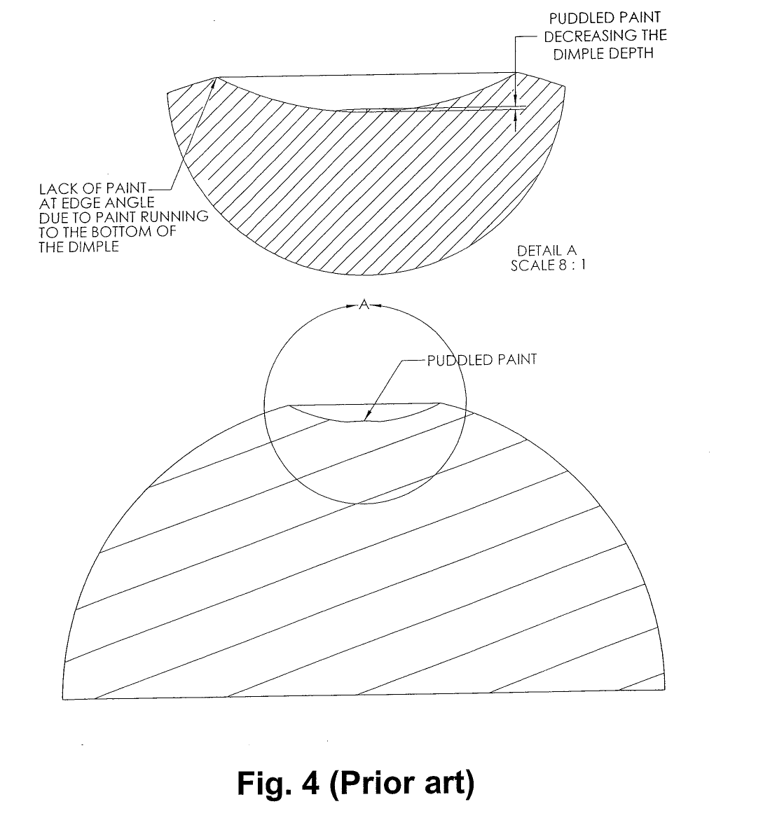

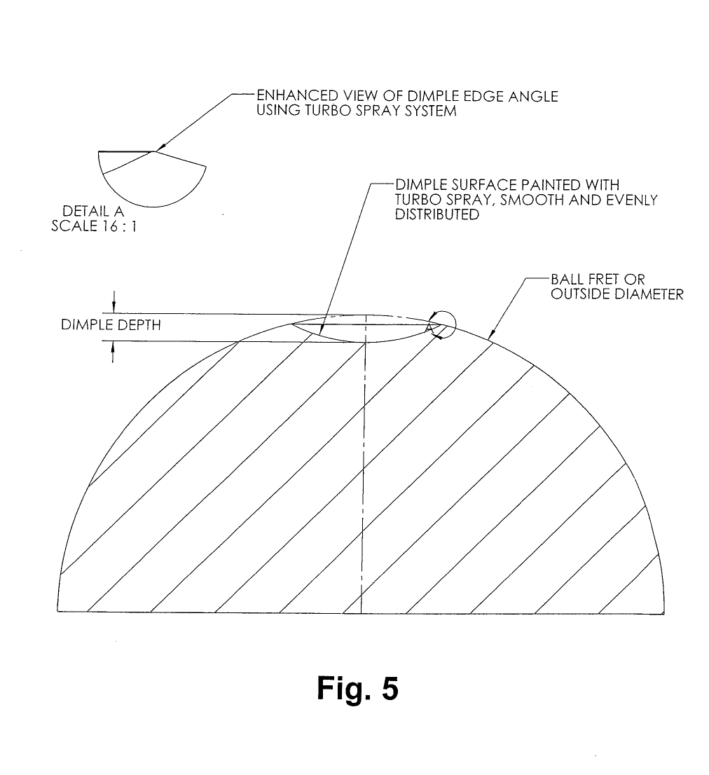

An added problem with the paint pressure build-up in the gun nozzle is that the air supply pressure to overcome the paint build-up has to be rather high (minimum of 15 psi), and this high air supply pressure creates a less than desired atomized paint spray mist. With the turbo spray method of the present invention, the guns are never shut-off, thus they do not accumulate paint in the gun nozzles, and therefore since they don't have to overcome the accumulated slug of paint in the gun nozzle, they can operate at a much reduced air supply pressure which is equal to or less than 6 psi. A benefit of the reduced air pressure is the creation of a gentler mist spray that coats the ball and subsequently allows for greater paint adhesion on the edge angles of the dimples, and less risk of paint running down into the dimple cavity. FIG. 5 illustrates a golf ball dimple painted with the turbo spray method of the present invention. It will be appreciated in FIGS. 4 and 5, that only one dimple is shown for clarity.

While it is apparent that the illustrative embodiments of the invention disclosed herein fulfill the objectives stated above, it is appreciated that numerous modifications and other embodiments may be devised by those skilled in the art. For example, the control system of the invention may be used to monitor the intensity of the spray pattern. Moreover, while the embodiments described herein generally describe the coating control system for use with a golf ball, other spherical objects, such as tennis balls, croquet balls, racquetball balls, pool balls, and the like are also contemplated for use with the present invention. In addition, the features of one embodiment can be used with the features of another embodiment. Therefore, it will be understood that the appended claims are intended to cover all such modifications and embodiments which would come within the spirit and scope of the present invention.

What is claimed is:

1. A method for applying a coat of paint on a golf ball, the method comprising:
providing an endless conveyor within an enclosed paint booth, the conveyor supporting a multitude of open sided spindle cups;
placing a golf ball in each spindle cup;
rotating the golf ball when in position to be painted;
providing two continuously spraying paint guns operating at a relatively low atomizing spray pressure;
directing the continuously spraying paint guns at angles to a surface of the rotating golf ball; and
spraying the paint at the rotating ball while maintaining a constant flow of paint and a constant movement of the conveyor; and
curing the ball.

2. The method according to claim 1, wherein the paint gun angle to the golf ball surface is about 5° to 60°.

3. The method according to claim 2, wherein the paint gun angle to the golf ball surface is about 28° to 40°.

4. The method according to claim 1, wherein the ball rotates between about 300 to 500 rpm.

5. The method according to claim 1, wherein one paint gun is an upper paint gun and the other is a lower paint gun.

6. The method according to claim 1, wherein the atomizing air spray pressure is equal to or less than 6 psi.

7. The method according to claim 1, wherein the paint guns do not cycle on and off.

8. The method according to claim 1, wherein a multitude of golf balls move on the conveyor at a rate of 200 per minute.

9. The method according to claim 8, wherein the golf balls on the conveyor are on a center line of 2 inches from each other.

10. The method according to claim 9, wherein the method provides for the application of a coating of more than 12,000 golf balls per gallon of paint.

11. The method according to claim 9, wherein the cover is about 0.030 inch thick.

12. A golf ball having a coat of paint applied to a cover surface, wherein the coat of paint is spray coated on the surface at an air pressure equal to or less than 6 psi.

13. The golf ball of claim 12, wherein the coat of paint is applied to the cover surface at an angle between about 5° to 60°.

14. The golf ball of claim 13, wherein the coat of paint is applied to the cover surface at an angle between about 32° to 40°.
